(19) United States
(12) Patent Application Publication
(10) Pub. No.: US 2002/0010928 A1
(43) Pub. Date: Jan. 24, 2002

(54) Method and system for integrating internet advertising with television commercials

(76) Inventor: Ranjit Sahota, Fairfax, CA (US)

Correspondence Address: Sang Hui Michael Kim, BLAKELY, SOKOLOFF, TAYLOR & ZAFMAN LLP, 12400 Wilshire Boulevard, Seventh Floor, Los Angeles, CA, 90025-1026, US

(21) Appl. No.: 09/841,149

(22) Filed: Apr. 23, 2001

Related U.S. Application Data
(60) Provisional application No. 60/199,686, filed on Apr. 24, 2000.

(51) Int. Cl. G06F 3/00

(52) U.S. Cl. 725/40

(57) ABSTRACT

A method and system are disclosed for integrating Internet advertising with television commercials. For one method, interactive content (e.g., Internet advertising content) is automatically integrated with television (TV) broadcast content (e.g., TV commercial content) for display. The interactive content can be integrated with the TV broadcast content without modification of the original interactive content and TV broadcast content.

### RELATED APPLICATION

This application is related to and claims priority to U.S. Provisional Application 60/199,686 entitled, “METHOD AND SYSTEM FOR TRANSFORMING CONTENT FOR EXECUTION ON MULTIPLE PLATFORMS,” filed on Apr. 24, 2000, the disclosure of which is hereby incorporated herein by reference.

### FIELD OF THE INVENTION

The present invention relates generally to interactive television. More particularly, the present invention relates to a method and system for integrating Internet advertising with television commercials.

### BACKGROUND OF THE INVENTION

Today, advancements in television systems provide a wide variety of services and applications for television users. One such advancement is interactive television (“iTV”). In an iTV environment, enhanced, interactive content can be provided to a user via the TV. For example, a user can access interactive content (e.g., a web page) on the Internet or World Wide Web via a browser operating on the TV. Thus, iTV allows the interactive and transactional capabilities of the Internet to be provided to TV users.

In addition, the iTV environment extends capabilities for traditional TV advertisers. For instance, TV advertisers can modify a TV commercial with interactive content to provide interactivity with TV users (“interactive commercials”). Hence, interactive commercials allow advertisers to present a wide range of possibilities for TV users that were not available in traditional television systems such as on-line purchasing of goods and services associated with a TV commercial.

A disadvantage with current implementations for providing interactive commercials is that the producer of a television commercial must modify the commercial to add interactive data and content before broadcasting the commercial. Thus, such a process requires additional production and editing of the commercial. Furthermore, if the interactive elements are Internet content, the elements have to be downloaded, which creates an unacceptable delay for users. Another disadvantage of current implementations is that integrating interactive content with commercials requires creation of specific new assets and new targeting and campaign software for each commercial. As such, current implementations do not provide a seamless integration of existing assets to generate new interactive commercial advertising services.

### SUMMARY OF THE INVENTION

A method and system are disclosed for integrating Internet advertising with television commercials. In one embodiment, interactive content (e.g., Internet advertising content) is automatically integrated with television (TV) broadcast content (e.g., TV commercial content) for display. The interactive content can be integrated with the TV broadcast content without modification of the original interactive content and TV broadcast content.

Other features and advantages of the present invention will be apparent from the accompanying drawings, and from the detailed description, which follows below.

### BRIEF DESCRIPTION OF THE DRAWINGS

The present invention is illustrated by way of example, and not limitation, in the figures of the accompanying drawings in which like reference numerals refer to similar elements and in which:

FIG. 1A illustrates an exemplary interactive television system in which the present invention can be implemented;

FIG. 1B illustrates a simplified internal block diagram of the set-top box of FIG. 1A according to one embodiment;

FIG. 2 illustrates an integration platform architecture of FIG. 1A according to one embodiment;

FIG. 3 illustrates a flow chart of a basic operation for automatically integrating Internet advertising content with television commercial content according to one embodiment;

FIG. 4 illustrates a flow chart of an operation to launch interactive services via an Internet advertisement integrated with a TV commercial according to one embodiment;

FIG. 5A illustrates an exemplary screen shot of interactive advertising content integrated with a television commercial; and

FIG. 5B illustrates an exemplary screen shot of Internet content that is launched from the interactive advertising content of FIG. 5A.

### DETAILED DESCRIPTION

A method and system are described for integrating Internet advertising with television commercials. In one embodiment, interactive content (e.g., Internet advertising content) is automatically integrated with television (TV) broadcast content (e.g., TV commercial content) for display. The interactive content can be integrated with the TV broadcast content without modification of the original interactive content and TV broadcast content.

The content integration techniques described herein can avoid using additional production or editing of existing TV commercials to make them interactive. In particular, existing television commercials and existing Internet advertising banners can be easily integrated and combined into a complete end-to-end system. Such a system can integrate existing Internet advertising inventory systems and existing TV commercial inventory systems with interactive television subsystems into a single cohesive system. In such a system, broadcasters or content providers can target specific users with interactive content (e.g., an advertisement banner) integrated with specific TV commercial content.

In the following embodiments, content integration techniques are described in connection with integrating Internet advertising content with TV commercial content. However, the content integration techniques described herein are not intended to be limited to any specific types of content and can easily be implemented with other types of content. For example, the techniques described herein can be used to integrate interactive Internet content related to a baseball team (e.g., a URL of a website for a baseball team) with a broadcast of a baseball game in which the baseball team is playing.

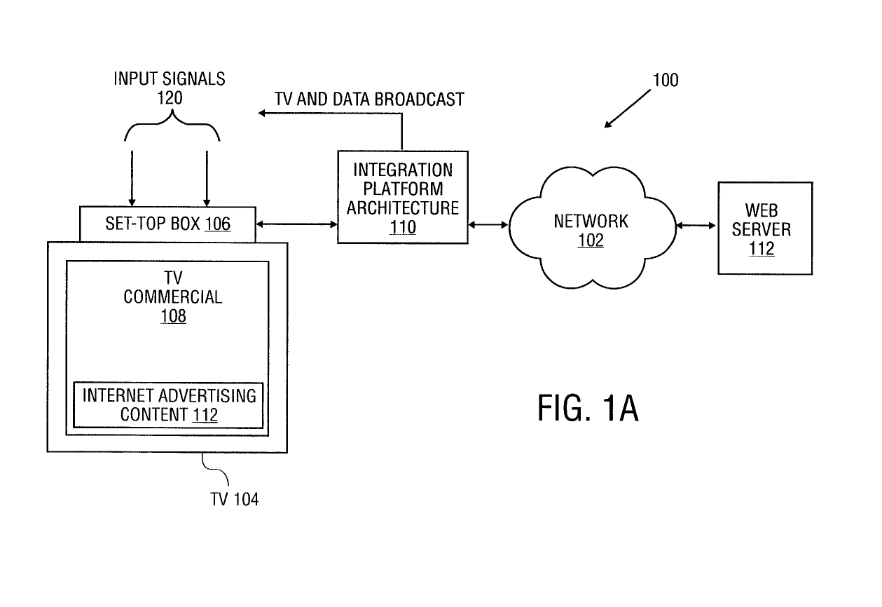

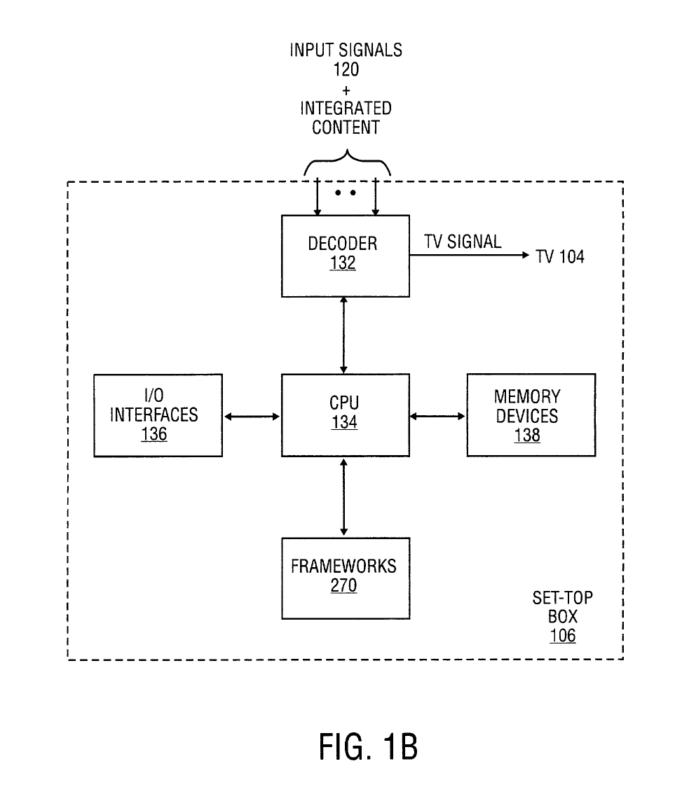

FIG. 1A illustrates an exemplary interactive television system 100 in which the present invention can be implemented. Referring to FIG. 1, interactive television system 100 includes a set-top box 106 connected to a TV 104. Set-top box 106 and TV 104 can receive inputs from a remote controller 122. TV 104 is shown to have a network 102 connection capability. That is, TV 104 can be connected to network 102 via set-top box 106. In one embodiment, TV 104 can receive and display Internet advertisement content 112 integrated with TV commercial 108. Internet advertisement content 112 can interact with content on web server 112. Set-top box 106 can be connected to network 102 through integration platform architecture 110 or directly through an input/output (I/O) interface such as a telephone line.

Set-top box 106 is a receiver for TV 104. TV 104 is a display device. TV 104 can support analog, Digital Video Broadcasting (DVB), Advanced Television Systems Committee (ATSC) or any of the other known TV standards. Set-top box receives input signals 120 (e.g., television signals) to display on TV 104. Input signals 120 can be broadcast signals from a plurality of programming sources. For example, settop box 106 can receive broadcast signals as input signals 120 from an antenna, cable, or satellite source. Input signals 120 can be analog or digital signals. Set-top box 106 can provide on-screen displays (OSDs) or graphical user interfaces (GULs) to facilitate interactive services, e.g., accessing content on the Internet. As shown in FIG. 1A, settop box 106 can be controlled by a user of remote controller 122. Alternatively, set-top box 106 can be controlled by other types of input devices such as, for example, an infrared (IR) keyboard.

Set-top box 106 also receives input from integration platform architecture 110. In one embodiment, integration platform architecture 110 provides set-top box 106 with Internet advertising content 112 that is integrated automatically with TV commercial 108 for display on TV 104. As will be described in further detail below, integration platform architecture 110 can integrate automatically specific types of TV commercials with specific types of Internet advertisements. For example, an Internet advertisement banner for a clothing company obtained from a website can be integrated with a TV commercial for the same clothing company on TV 104.

Integration platform architecture 110 can be a computing system including multiple sub-systems for automatically integrating and delivering Internet advertisements with TV commercials. Alternatively, integration platform architecture 110 can include hardware and/or software modules operating within set-top box 106 to integrate automatically Internet advertising content with TV commercials. Integration platform architecture 110 can also transform content, e.g., a web page on web server 112, to be displayable for an application, e.g., a browser running on TV 104.

In one embodiment, integration platform architecture 110 integrates existing Internet advertisement content (e.g., a standard add banner from a website) with specific TV commercial content or programming in a synchronized manner. Integration platform architecture 110 can also link automatically the Internet advertisement content with the broadcasting of the TV commercial content. Such an automatic linking of Internet advertisement content with TV commercial content can be automatically “triggered” from a series of rules and instructions. The triggering can be based on personalization rules and demographic targeting rules.

For example, integration platform architecture 110 can target a specific audience (e.g., young adults) by integrating Internet advertisement content 112 for TV commercial 108 during a popular young adult program defined by a rule. In another embodiment, integration platform architecture 110 can target specific set-top boxes of a geographical area for integrating Internet advertising content 112 with TV commercial 108 defined by another rule. Such integration can use existing Internet advertisement content (e.g., an add banner) and TV commercials. Thus, integration platform architecture 110 allows a TV commercial to be enhanced with existing Internet advertisement content without any modifications to the TV commercial.

In one embodiment, network 102 is the Internet hosting the World Wide Web (WWW). The WWW allows for a uniform way of accessing information on the Internet using HTML compliant browsers. Network 102 can be other types of networks such as, for example, a local area network (LAN) or a wide area network (WAN). Network 102 can also represent wired or wireless networks. Although one web server 102 is shown in FIG. 1A, any number of web servers can be connected to network 102. Furthermore, other types of network devices can also be connected to network 102, which can provide content for TV 104, such as, for example, a network router, bridge, gateway, or other like network devices.

Remote controller 122 is a control device for a user to provide inputs (e.g., infrared (IR) or radio frequency (RF) signals) to set-top box 106 and/or TV 104. Remote controller 122 can include alphanumeric keys, options keys, functions keys, and other like keys to operate set-top box 106 or TV 104. In one embodiment, a user can interact with Internet advertising content 112 using remote controller 122. n particular, a user can access and navigate through set-top browser 108 on TV 104 by pressing selectively certain buttons or keys on remote controller 122. Interactive television system 100 can also be implemented in numerous configurations. For example, TV 104 can have the functionality of set-top box 106 contained internally. TV 104 can also be a computing device, which can display television signals. Furthermore, the functionality of integration platform architecture 110 can be separate processing units or hardware and/or software modules operating within set-top box 106.

FIG. 1B illustrates a simplified internal block diagram of the set-top box 106 of FIG. 1A according to one embodiment. For purposes of clarity, only the basic components of set-top box 106 are shown in block diagram form. Set-top box 106 is configured to provide interactive television content. For example, set-top box 106 can support and operate interactive TV standards such as, for example, Advanced Television Enhancement Form (ATVEF), Internet Protocol (IP) multicasting, multi-protocol encapsulation for Digital Video Broadcasting (DVB), or broadcast HTML standards for Digital Television (DTV). Set-top box 106 thus provides for enhanced, interactive television content services.

Referring to FIG. 1B, set-top box 106 includes a central processing unit (CPU) 134 coupled to memory devices 138, input/output (110) interfaces 136, decoder 132, and device frameworks 270. Decoder 302 can receive inputs signals 120 and/or integrated content, e.g., Internet advertising content 112 integrated with TV commercial 108. The integrated content can be enhanced, interactive television content. Decoder 132 can receive input signals 120 as analog (NTSC) or digital (ATSC) signals from a number sources including terrestrial, cable, and satellite sources. Decoder 132 outputs a TV signal to TV 104, which can be enhanced with the integrated content as described herein.

CPU 134 is the central control mechanism for set-top box 106. CPU 134 can execute code or instructions stored in memory devices 138 or device frameworks 270 or external storage devices via network 102. For example, I/O interfaces 136 may include a connection to network 102 provided by a dial-up modem. I/O interfaces 136 can also include an (IR) or (RF) interface for receiving inputs from remote controller 122.

Device frameworks 270 include software modules, which are used to implement interactive television services for set-top box 106. In one embodiment, device frameworks 270 are thin client software modules operating within set-top box 108. In an alternative embodiment, device frameworks 270 are thin client software modules operating within integration platform architecture 110. As will be explained in further detail below, device frameworks 270 interface with applications within set-top box 106 to display integrated Internet advertisement content with TV commercials. In one embodiment, frameworks 270 receive “triggers” to allow for the integration of Internet advertisement content with TV commercials. For example, device frameworks 270 can store instructions to enable real time response to trigger automatically interactive Internet content with TV commercial content.

Memory devices 138 can include a machine-readable medium that provides (i.e., stores and/or transmits) information in a form readable, e.g., by CPU 134. Memory devices 308 may include a read only memory (ROM), random access memory (RAM), magnetic disk storage media, optical storage media, or flash memory devices. The code or instructions stored in memory devices 138 can be represented by carrier wave signals, infrared signals, digital signals, and by other like signals.

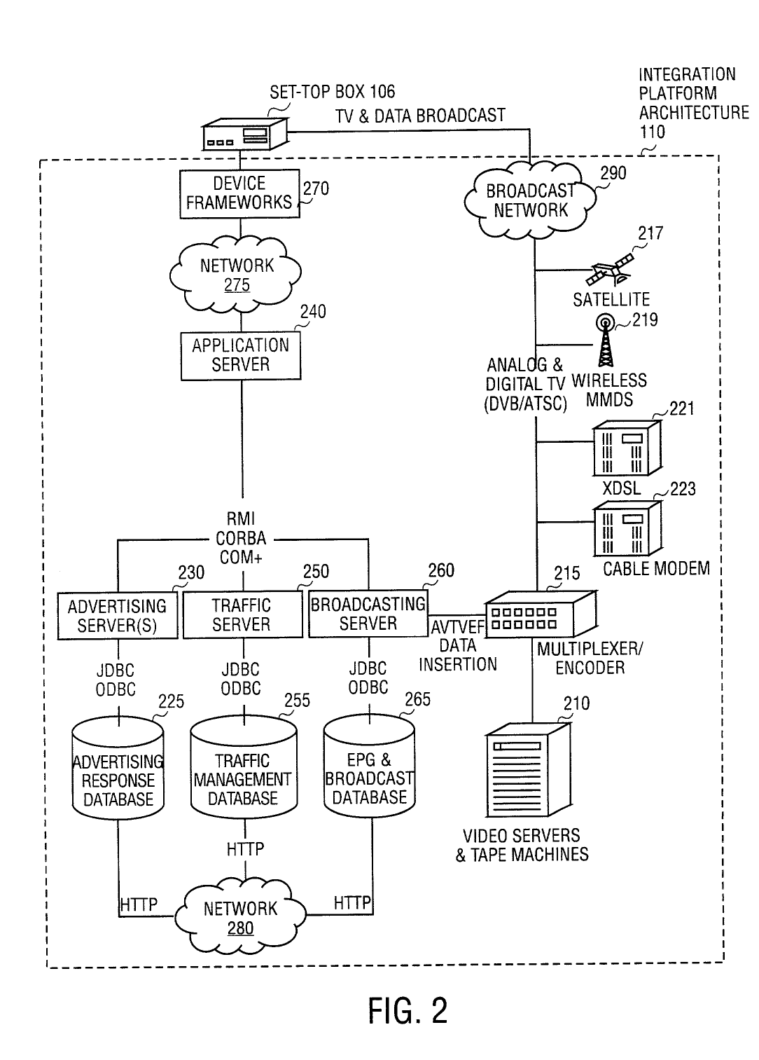

FIG. 2 illustrates an integration platform architecture 110 of FIG. 1A according to one embodiment. Integration platform architecture 110 provides details of the subsystems and networks to integrate Internet advertising content with television commercials. The subsystems can include hardware and/or software modules to integrate the content as described herein. For purposes of illustration, integration platform architecture 110 is shown communicating with a single set-top box 106. Integration platform architecture 110, however, can be implemented to communicate with a plurality of set-top boxes.

Referring to FIG. 2, set-top box 106 can receive TV and data broadcast from a plurality of sources such a satellite source 290, wireless Multipoint Microwave Distribution System (MMDS) source 219, x digital subscriber loop (DSL) source 221, cable modem source 223, and video server and tape machine source 210 via broadcast network 290. Integration platform architecture 110 includes device frameworks 270, application server 240, advertising server 230, advertising response database 235, traffic server 250, traffic management database 255, broadcasting server 260, and electronic program guide (EPG) and broadcast database 265.

Device frameworks 270 are software modules. In one embodiment, device frameworks 270 are software modules operating within set-top box 106. In an alternative embodiment, device frameworks 270 are software modules operating within a separate processing device external to set-top box 106. In one embodiment, applications or code for device frameworks 270 are downloaded into set-top box 106. Applications or code can also be pre-loaded in set-top box 106, e.g., in a flash memory device.

In one embodiment, device frameworks 270 receive ATVEF triggers and content from application server 240. Application server 240 can also send data and/or media assets from broadcasting server 260 to device frameworks 270. Device frameworks 270 operate to handle events based on received ATVEF triggers and data and/or media content sent from application server 240. ATVEF triggers are mechanisms to alert receivers or set-top boxes (e.g., set-top box 106) of incoming content enhancements.

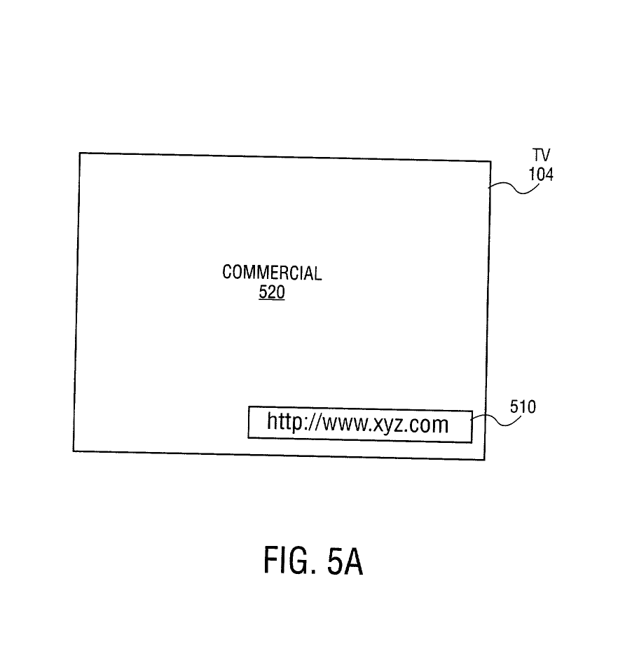

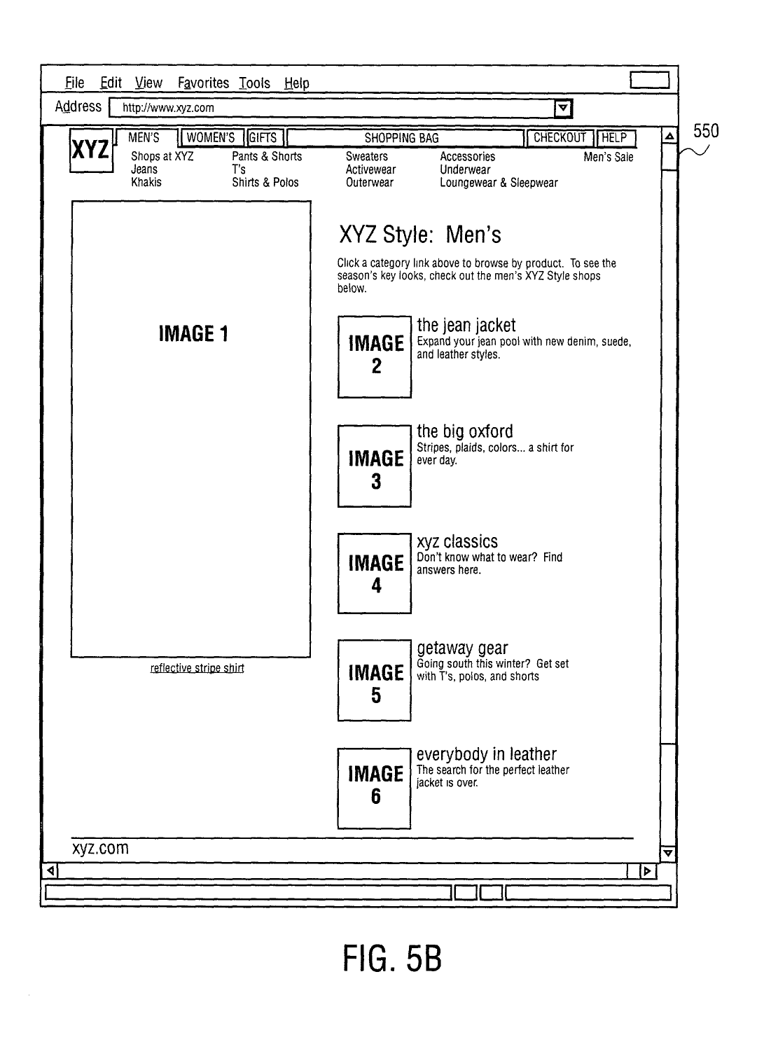

In particular, ATVEF triggers include information about enhancements that are available to the user. For example, an ATVEF trigger can include a standard Universal Resource Locator (URL) location for enhanced content. The enhanced content can be broadcasted via broadcast network 290 or stored and transmitted via a local network such as network 280. Furthermore, the enhanced content may be already stored within set-top box 106. For example, as shown in FIG. 5A, device frameworks 270 can receive a “trigger” to combine commercial 520 with enhanced content 510 showing a URL location “http://www.xyz.com,” which is a location of an exemplary clothing retail website.

In another embodiment, the trigger may include readable description of content such as, for example, “press the browse button for more information about the product being advertised,” which can be displayed on TV 104 by set-top box 106. The trigger can also include JavaScript code. For example, the trigger can be used to execute another piece of JavaScript code within an webpage. The trigger can also be used for other purposes such as synchronization of enhanced content with specific broadcast content. For example, the trigger can be used to integrate enhanced content 510 when commercial 520 is being broadcasted.

Device frameworks 270 communicates with application server 240 via network 275, which can include a residential broadband network. In one embodiment, application server 240 provides the necessary information and data and instructs device frameworks 270 to integrate automatically an existing Internet advertising content, e.g., an advertisement banner, with a television commercial being broadcasted to set-top box 106 via broadcast network 290. As such, existing television broadcast assets (“commercial”) can be quickly made interactive by taking existing Internet advertising content and integrating them into a single video broadcast for TV 104.

Application server 240 is responsible for the overall logic, control, and management of the interactive subsystems, which include advertising server 230, traffic 2r: server 250, and broadcasting server 260 and corresponding databases 235, 255, and 265, respectively. The servers 230, 240, 250, and 260 can communicate with each other using a Remote Method Invocation (RMI) protocol, CORBA, COM+, or another well-known communication protocols.

Application server 240 interfaces with existing Internet resource managers (not shown in this view) for handling user requests and routing them to appropriate servers 230, 250, and 260 for fulfillment. For example, if a user wants more information regarding a particular advertisement, application server 240 can send a request to advertising server 230 to access further content related to the advertisement in advertising response database 225. If the requested content is not available in advertising response database 225, application server 240 can search the Internet, e.g., accessing network 280 for the requested content.

Application server 240 can also track user actions operating set-top box 106. For instance, application server 240 can track the number of times a user of a specific set-top box 106 selects a particular interactive service. In particular, application server 240 can be used to track the number of times a user interacts with Internet advertising content 112 each time commercial 108 was displayed on TV 104. In one embodiment, device frameworks 207 is programmed or configured to provide such information to application server 240. Application server 240 can than store tracked information in a database.

Advertising server 230 interfaces with advertising response database 235. Advertising response database 235 stores Internet based advertising content that can be integrated with a TV commercial being broadcasted on TV 104. In one embodiment, advertising content stored in advertising response database 235 is tagged with meta-data, which can be used to categorize the content and to link the content with a particular TV commercial. For example, as shown in FIG. 5A, interactive content 510 can be stored in advertising response database 235 and tagged with meta-data to be associated with commercial 520. The meta-data is used to localize and personalize the interactive content based on, e.g., zip code of residence of the user, demographic profiling, collaborative filtering rules, or business logic rules.

Application server 240 uses advertising server 230 to manage and deliver the interactive advertising content stored in advertising response database 235 to users of set-top box 106 or other like receivers. For example, advertising response data 235 can store a plurality of ATVEF triggers to provide interactive enhancements on TV 104. In one embodiment, advertising server 230 can be used to customize and localize interactive Internet advertisement for a specific market or geographic region. For example, advertising server 230 can store specific rules, which specify the personalization of content for a particular user, i.e., providing a local restaurant advertisement content with a local TV commercial for the restaurant.

Traffic server 250 interfaces with traffic management database 255. In one embodiment, traffic management database 255 is an enterprise resource planning (ERP) database, which stores TV commercial content. Traffic management database 255 can also store meta-data related to the stored TV commercial content. For example, the meta-data can include TV commercial type information, length of TV commercial content, times to play the TV commercial content, and etc.

Traffic server 250 can be managed by application server 240 to deliver selectively TV commercial content stored in traffic management database 255 for display on TV 104. Traffic server 250 can be used to update dynamically information stored in traffic management database 255. For example, a TV producer or technical staff can control application server 240 or traffic server 250 to update information in traffic management database 255. In one embodiment, traffic server 250 is responsible for providing all TV commercial content to be displayed on TV 104 and on other TV sets.

Broadcasting server 260 interfaces with electronic program guide (EPG) & broadcast database 265 (“broadcast database 265”). Broadcasting server 260 also interfaces with mutliplexer/encoder 215. Multiplexer/encoder 215 can provide ATVEF, VBI Encoding, MPEG Multiplexing, or IP encapsulation services to insert the data, media and content into a video broadcast stream (e.g., a TV commercial). In one embodiment, the formatting and structure of the content is based on ATVEF broadcast and delivery standards.

Broadcasting server 260 manages the delivery of content, triggers and media to the TV & data broadcast (“TV broadcast”). In one embodiment, broadcasting server 260 is synchronized with advertising server 230 and traffic server 250 to provide TV commercial content stored in traffic management database 255 and Internet advertising content (e.g., by way of an ATVEF trigger) stored in advertising response database 225 to the TV broadcast via multiplexer/encoder 215.

In one embodiment, broadcasting server 260 stores advertising content and TV commercial content in advance in broadcast database 265. Broadcasting server 260 can also store scheduling and asset information in broadcast database 265, which can be used to determine timing and scheduling for broadcasting the integrated content. In one embodiment, broadcasting server 260 sends the TV commercial content with an ATVEF trigger and/or advertising data or content to multiplexer/encoder 215, which uses the ATVEF trigger to integrate the advertising content with the TV commercial content.

Broadcasting server 260 can be used to search, load and package advertising content. In one embodiment, broadcasting server 260 can store advertising content as CDF package files based on ATVEF standard. In an alternative embodiment, broadcasting server 260 can use a different standards such as EIA-608 for recommended line 21 data insertion service or DVB standards. In one embodiment, broadcasting server 260 uses a scheduling algorithm to trigger or integrate content for set-top box 106. For example, broadcasting server 260 can use “cache-ahead value” process to assign for each residential network (e.g., network 275) exact times to trigger integration of Internet advertising content with TV commercials.

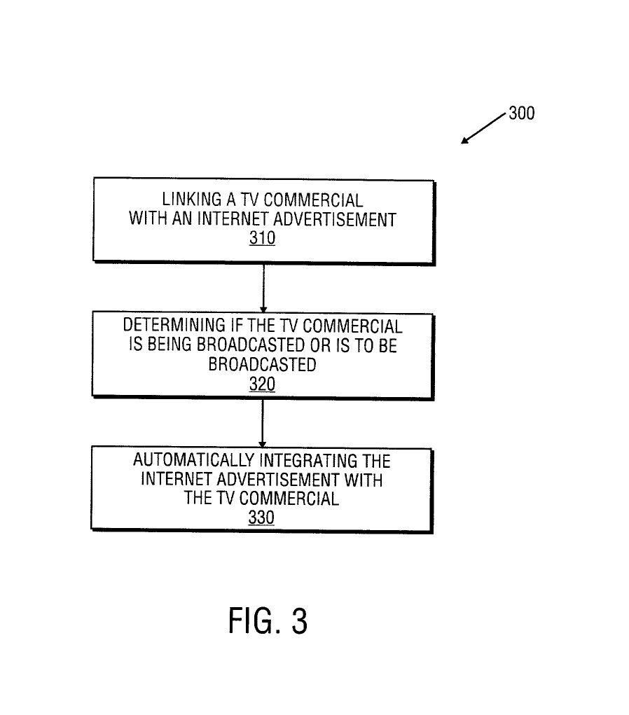

FIG. 3 illustrates a flow chart of a basic operation 300 for automatically integrating Internet advertising content with television commercial content according to one embodiment. Initially, operation 300 begins at operation 310.

At operation 310, a TV commercial is linked with an Internet advertisement. For example, advertising server 230 can store links as meta-data in advertising response database 235 that can link TV commercial 520 with interactive content 510 as shown in FIG. 5A.

At operation 320, a determination is made if the TV commercial is being broadcasted or is to be broadcasted. For example, application server 240 can determine if set-top box 106 is to receive TV commercial content, which is to be “triggered” for integrating an Internet advertising content such as interactive content 510.

At operation 330, the Internet advertisement is automatically integrated with the TV commercial. For example, broadcasting server 260 can integrate the content, which is to be delivered to multiplexer/encoder 215 (e.g., by inserting an ATVEF trigger) and then sent to set-top box 106, or, alternatively, to be delivered to settop box 270 via application server 240 and device frameworks 270.

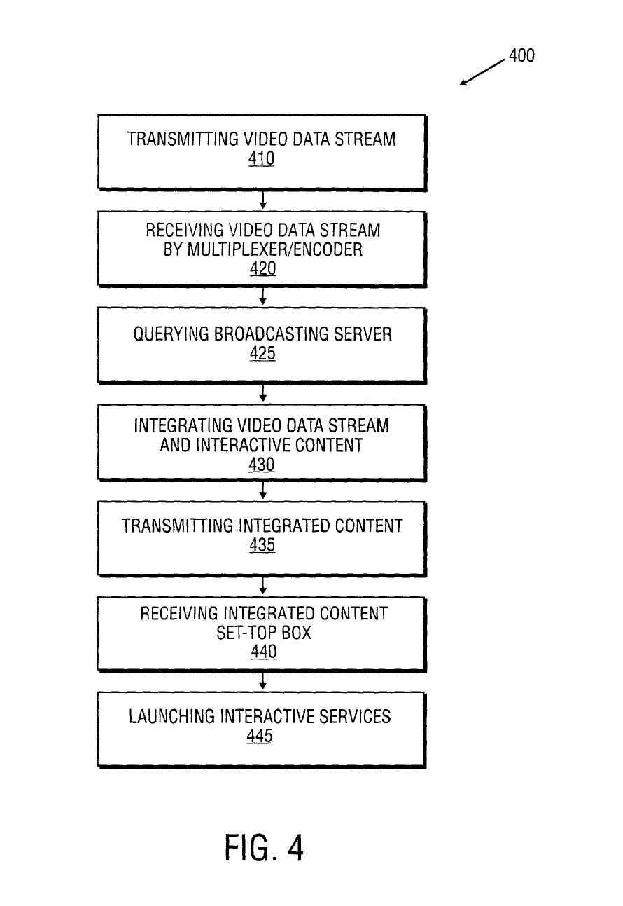

FIG. 4 illustrates a flow chart of an operation 400 to launch interactive services via an Internet advertisement integrated with a TV commercial according to one embodiment. Initially, operation 400 begins at operation 410.

At operation 410, a video data stream is transmitted. For example, video server 210 can send a video datastream to multiplexer/encoder 215.

At operation 420, the video data stream is received by multiplexer/encoder 215.

At operation 425, multiplexer/encoder 215 queries broadcasting server 260 to determine if the video stream is to be integrated with interactive content. If not, multiplexer/encoder 215 can transmit the video stream to set-top box as is without the integrated interactive content.

At operation 430, if broadcasting server 260 responds to multiplexer/encoder 215 that the video stream is to be integrated with interactive content, broadcasting server 260 will send an ATVEF trigger to multiplexer/encoder 215. Multiplexer/encoder 215 then integrates interactive content in realtime based on the ATVEF trigger.

At operation 435, multiplexer/encoder 215 then transmits the integrated content to set-top box 106.

At operation 440, set-top box 106 receives the integrated content. Device frameworks 270 within set-top 106 may further process the integrated content for display on TV 104. For example, as shown in FIG. 5A, set-top 106 sends interactive content of a URL location “http://www.xyz.com” for a clothing retailer with TV commercial 520, which is a commercial for the clothing retailer, for display on TV 104.

At operation 445, a user of TV 104 can launch interactive services by accessing interactive content 510. For example, a user accessing interactive content 510 will begin interacting with a website as shown in FIG. 5B related to the clothing retailer.

Thus, a method and system for integrating Internet advertising with television commercials have been described. The method and system provide an end-to-end framework for network operators and broadcasters to integrate seamlessly existing assets to generate new interactive advertising services. In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method for a display comprising:
automatically integrating interactive content with television (TV) broadcast content for display.

2. The method of claim 1, wherein the interactive content includes Internet advertising content and the TV broadcast content includes TV commercial content.

3. The method of claim 1, further comprising:
linking the interactive content with the TV broadcast content.

4. The method of claim 1, further comprising:
displaying the integrated content to allow a user to interact with the interactive content.

5. The method of claim 1, wherein the automatically integrating of the interactive content includes automatically integrating the interactive content with the TV broadcast content without modifying the interactive content and the TV broadcast content.

6. The method of claim 1, wherein the interactive content includes an advertising banner.

7. The method of claim 1, further comprising:
targeting specific receivers with the integrated content.

8. A system for integrating content comprising:
an integration unit to integrate automatically interactive content with television (TV) broadcast content for display.

9. The system of claim 8, wherein the interactive content includes Internet advertising content and the TV broadcast content includes TV commercial content.

10. The system of claim 1, further comprising:
a linking unit to link the interactive content with the TV broadcast content.

11. The system of claim 8, further comprising:
a receiving unit to receive the integrated content; and
a display unit to display the integrated content to allow a user to interact with the interactive content.

12. The system of claim 8, wherein the integration unit is to integrate automatically the interactive content with the TV broadcast content without modifying the interactive content and the TV broadcast content.

13. The system of claim 8, wherein the interactive content includes an advertising banner.

14. The system of claim 8, further comprising:
a targeting unit to target specific receivers with the integrated content.

15. A method for processing a video data stream, the method comprising:
receiving the video data stream;
downloading interactive content;
automatically integrating the interactive content with the video data stream; and
transmitting the integrated interactive content and video data stream to one or more receivers for display.

16. The method of claim 15, further comprising:
displaying the interactive content and the video stream; and
launching interactive services via the interactive content.

17. The method of claim 15, wherein the receivers include a set-top box.

18. The method of claim 15, wherein the video data stream includes TV commercial content.

19. The method of claim 15, further comprising:
customizing the interactive content for a specific market, group, or geographic region.

20. A system for processing a video data stream comprising:
a receiving unit to receive the video data stream;
a downloading unit to download interactive content;
an integration unit to integrate automatically the interactive content with the video data stream; and
a transmitting unit to transmit the integrated interactive content and video data stream to one or more receivers for display.

21. The system of claim 20, wherein the receivers include a set-top box.

22. The system of claim 20, wherein the video data stream includes TV commercial content.

23. The system of claim 20, further comprising:
a customizing unit to customize the interactive content for a specific market, group, or geographic region.

24. A machine-readable medium providing instructions, which if executed by a processor, causes the processor to perform an operation comprising:
automatically integrating interactive content with television (TV) broadcast content for display.

25. The machine-readable medium of claim 24, further providing instructions, which if executed by the processor, causes the processor to perform an operation comprising:
linking the interactive content with the TV broadcast content.

26. The machine-readable medium of claim 24, further providing instructions, which if executed by the processor, causes the processor to perform an operation comprising:
displaying the integrated content to allow a user to interact with the interactive content.

27. A machine-readable medium providing instructions, which if executed by a processor, causes the processor to perform an operation comprising:
receiving a video data stream;
downloading interactive content;
automatically integrating the interactive content with the video data stream; and
transmitting the integrated interactive content and video data stream to one or more receivers for display.
